(19) United States
(12) Patent Application Publication
(10) Pub. No.: US 2007/0119382 A1
(43) Pub. Date: May 31, 2007

(54) Bedding dispensing system and method

(76) Inventors: Daryl Austin, Newfane, NY (US); Edward J. Horeth, Rochester, NY (US)

Correspondence Address: JAECKLE FLEISCHMANN & MUGEL, LLP, 190 Linden Oaks, ROCHESTER, NY, 14625-2812, US

(21) Appl. No.: 11/290,327

(22) Filed: Nov. 30, 2005

(51) Int. Cl. A01K 1/00

(52) U.S. Cl. 119/452

(57) ABSTRACT

A system for dispensing clean bedding material in a plurality of cage components is provided. The system includes an inline conveyor having receiving and dispatch ends, wherein the inline conveyor transports the plurality of cage components from the receiving end to a respective filling position located at the dispatch end. The system also includes a bedding dispensing unit positioned over the dispatch end of the inline conveyor, wherein the dispensing unit operates to simultaneously dispense clean bedding into the cage components. The dispensing unit includes preferably three or four filling chutes positioned over the filling positions to simultaneously dispense the bedding material from the internal chamber into the cage components. The inline conveyor includes cage positioning guides that position the cage components in the filling position. The dispensing unit may include a window to allow an operator to view the level of bedding located in the bedding dispensing unit.

### TECHNICAL FIELD

The present invention relates to a bedding dispensing system and method; more particularly, the present invention is directed to a bedding dispensing system and method that efficiently and accurately dispenses clean cage bedding into one or more cage components.

### BACKGROUND OF THE INVENTION

A conventional cage system for holding small laboratory animals is typically a three piece assembly having a clear plastic bottom, a grill for holding food and water, and a lid that attaches to the bottom and holds the grill in place. A suitable bedding material, such as cedar shavings, may be added to the bottom portion of the cage assembly to absorb animal waste and spilled food.

While in use, the bedding becomes soiled, thereby necessitating the need for frequent cleaning of the cages. The cleaning process is typically a manual process that requires the cage components be manually disassembled, the soiled bedding be removed from the bottom portion of the cage, washed, and dried for reuse.

Instead of manually cleaning the cases, robotic arms are also known to assist laboratory personnel with the cage cleaning process. For example, after the cages are transported to a cage washing system, the robotic arms remove the soiled cage bottoms from a pallet, invert the cage bottoms to empty the soiled bedding material, and place the empty/soiled cage bottoms in an appropriate position on a conveyor. Since the pallet may also come into contact with the soiled material, the pallet is also placed on the conveyor by the robots so that they may be cleaned. The conveyor advances the cage bottoms and the pallets through a chamber or tunnel wash system, wherein the cage bottoms and pallets are cleaned by a suitable process, usually involving high pressure streaming water. Furthermore, a drying process is typically accomplished by subjecting the cleaned, yet wet cage bottoms and pallets, to high velocity heated air. The other cage components, such as the grill and lid, may be cleaned in a similar manner.

Upon completion of the cleaning process, an automated device, such as an additional robotic arm (i.e., clean side robot), places the cleaned pallet onto a stationary out-feed conveyor, clean bedding is added to the cages, and the cages are stacked on the clean pallet. Once a sufficient number of cages are stacked on the pallet, the out-feed conveyor is turned on and the pallet is moved to an end of the conveyor to be loaded onto a cart so that the cages may be returned to service.

Typically, clean bedding is dispensed into the clean cages using a rainfall type bedding dispenser. In operation, one or more clean cages simply pass underneath the rainfall dispenser while the rainfall dispenser sprinkles bedding over a general area wherein the cages catch some of the bedding falling from the dispenser. The method of filling the clean cages with bedding using a rainfall type dispenser presents a number of drawbacks and deficiencies. For example, the rainfall dispenser operates to sprinkle bedding over a general area, and does not directly dispense bedding into cages. Thus, there are certain areas in which there are no cages passing underneath the rainfall dispenser. In these unoccupied areas, the bedding being dispensed is wasted. In addition, the amount of bedding dispensed into each of the cages from the rainfall dispenser may be inconsistent. This may result in an inadequate amount of bedding being dispensed into a cage or a waste of bedding in the instance where the amount of bedding dispensed in a cage is more than the optimal amount. Moreover, the use of the rainfall type bedding dispenser causes a substantial amount of bedding particulates to be suspended in the air, thereby creating an undesirable work environment for the operator of the cage cleaning system.

Another method of dispensing clean bedding is by filling the cages using a bedding dispensing device. For example, after the cages have been cleaned, two cages may be positioned underneath separate bedding dispensing chutes so that an operator can independently dispense clean bedding into each of the cages. This particular manual fill or vacuum assisted dispensing process is problematic in that it results in an inconsistent amount of bedding being dispensed into each of the cases. Also, this process of dispensing clean bedding may be positioned in a location that is offset and not in line with the end of the cage cleaning system. As a result, the operator may have to move the clean cage from the cage cleaning system to a bedding dispensing location in order to complete the process. Thus, the efficiency of the cage cleaning process is reduced.

Accordingly, there exists a need for a bedding dispensing system and method that accurately and efficiently dispenses clean bedding into the cage components. In addition, there exists a need for a bedding dispensing system and method that reduces the amount of bedding particulates that are suspended in the air when the bedding is dispensed into the cage components. The present invention fills these needs as well as other needs.

### SUMMARY OF THE INVENTION

In order to overcome the above stated problems, the present invention provides a bedding dispensing system that is positioned inline with the cage cleaning conveyor and allows a plurality of cage bottoms to be simultaneously filled with a metered amount of clean bedding material to reduce the amount of clean bedding that is wasted. Thus, different types and sizes of cage bottoms can be efficiently filled using the bedding dispensing system. Further, the use of separate filling chutes allows the clean bedding material to be directly dispensed into the cage bottom, thereby reducing the amount of bedding particulates that are suspended in the air during the dispensing process. Moreover, the main bedding dispensing unit includes a window or transparent material covering an access port on the side of the bedding storage hopper for identifying how much clean bedding is located within the bedding storage hopper.

In particular, the present invention includes a system for simultaneously dispensing clean bedding material into a plurality of cage components. The system may include an inline conveyor and a bedding dispensing unit. The inline conveyor has a receiving end and a dispatch end, wherein the inline conveyor transports the at least one cage component from the receiving end to a filling position located at the dispatch end. The bedding dispensing unit is positioned over the dispatch end of the inline conveyor, wherein the bedding dispensing unit operates to simultaneously dispense clean bedding into the plurality of cage components, and preferably three to four cage components.

The inline conveyor may include at least one cage positioning guide that positions the plurality of cage components underneath the bedding dispensing unit in the filling position. At least one cage presence sensor may be used to determine when the plurality of cage components are located in the filling position.

The bedding dispensing unit may include a bedding storage hopper having an internal chamber for storing the bedding material. The bedding storage hopper may also include a plurality of filling chutes positioned over the filling position to dispense the bedding material from the internal chamber into the plurality of cage components. Further, the bedding storage hopper includes bottom end having a tapered portion that funnels toward the plurality of filling chutes. A valve is coupled with the filling chutes to control the amount of bedding dispensed by the filling chutes. An operator interface may be used to selectively open and close the valve to control amount of bedding dispensed by the filling chutes. An agitator may also be positioned within the internal chamber of the bedding storage hopper to prevent the bedding material from clumping inside the internal chamber.

The present invention also provides a method for filling a plurality of cage components with bedding material. The method includes providing an inline conveyor having a receiving end and a dispatch end, positioning a bedding dispensing unit over the dispatch end of the inline conveyor, transporting each of a plurality of cage components from the receiving end to a respective filling position located at the dispatch end, and simultaneously dispensing clean bedding from the internal chamber of the bedding dispensing unit into the plurality of cage components.

The method may further provide at least one cage positioning guide to position the plurality of cage components underneath the bedding dispensing unit in the respective filling positions. In addition, the method may include sensing when the plurality of cage components are located in the respective filling positions. Further, the method allows for the amount of bedding material in the bedding dispensing unit to be seen through a window in the bedding dispensing unit. Also, the bedding material may be agitated when the bedding material is dispensed into the plurality of cage components.

### BRIEF DESCRIPTION OF THE DRAWINGS

The above-mentioned and other features and advantages of this invention, and the manner of attaining them, will become appreciated and be more readily understood by reference to the following detailed description of one embodiment of the invention in conjunction with the accompanying drawings, wherein:

FIG. 1 is a flow diagram of an automated cage washing system;

FIG. 2 is a perspective view of a soil side of the automated cage washing system;

FIG. 3 is a perspective view of a clean side of the automated cage washing system;

FIG. 4 is a side elevation view of a bedding dispensing system according to the present invention;

FIG. 5 is a top view of the bedding dispensing system shown in FIG. 4; and

FIG. 6 is a front elevation view of the bedding dispensing system shown in FIG. 4.

### DESCRIPTION OF THE PREFERRED EMBODIMENT

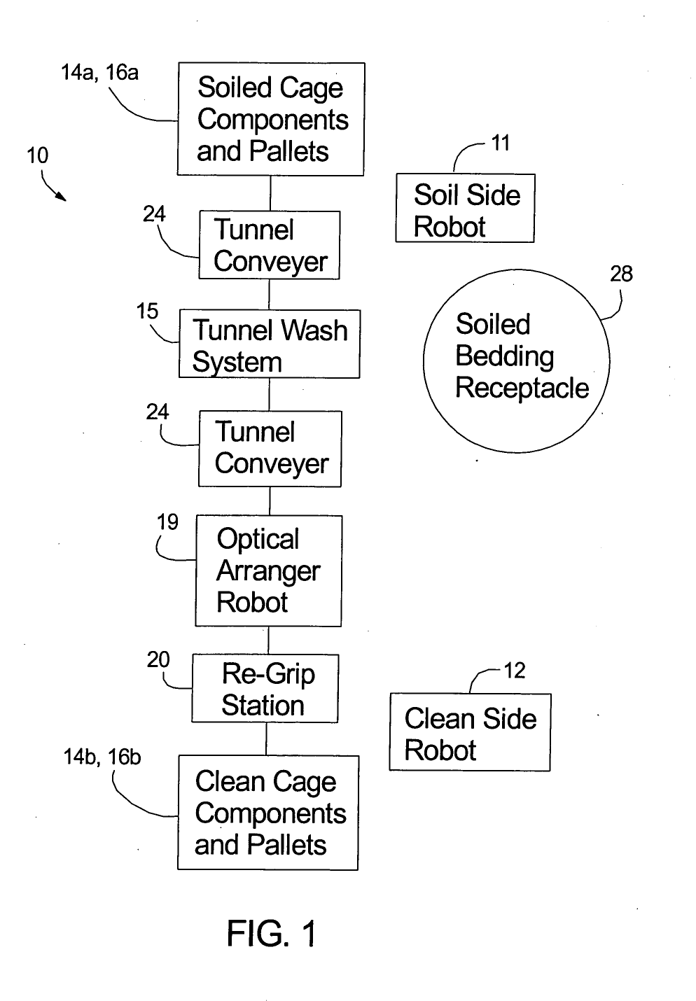

Referring to the drawings in detail, and specifically to FIG. 1, a system for cleaning animal cages is shown and is designated as reference numeral 10. The system utilizes of a pair of loading/unloading robots, referred to hereinafter as a soil side robot 11, and a clean side robot 12. Additionally, the system also utilizes an optical arranger robot 19. Using robots in the washing system 10 is beneficial in that they limit human exposure to the soiled cages, and reduce the repetitive steps associated with the loading and unloading the cage components.

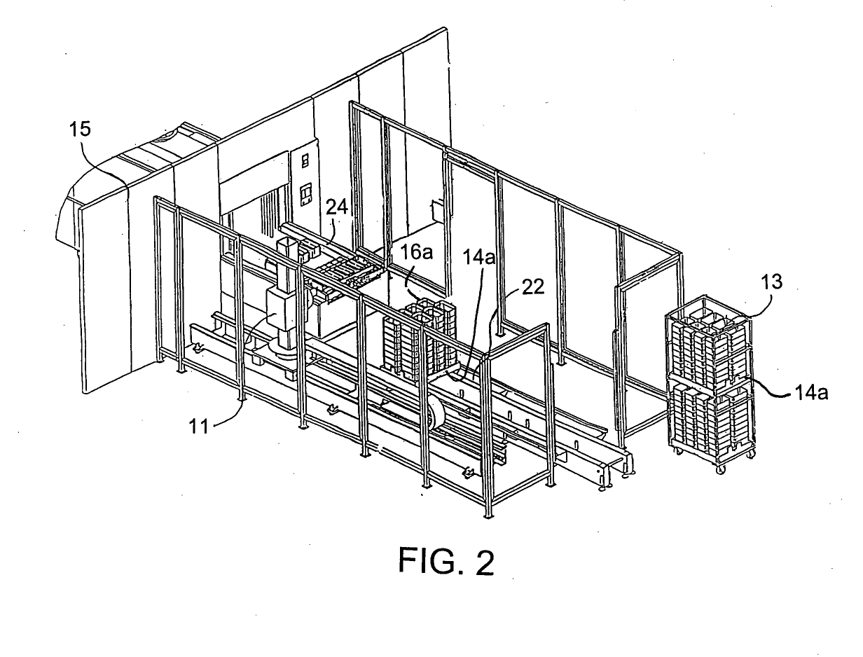

With additional reference to FIG. 2, one or more soiled cage bottoms 16a arrive at the cleaning area on a component cart 13, or any other suitable device for transporting a plurality of soiled bottoms. Cart 13 further comprises at least one soiled component rack or pallet 14a that operates to hold a plurality of soiled cage bottoms 16a. Pallet 14a holding one or more soiled cage bottoms 16a is removed from cart 13 and attached to an in-feed conveyor 22. Once pallet 14a is securely placed on in-feed conveyor 22, the pallet 14a holding soiled cage bottoms 16a advances toward soil side robot 11. Soil side robot 11 grasps one or more cage bottoms 16a from pallet 14a, inverts cage bottoms 16a over a soiled bedding receptacle 28 (FIG. 1), or any device suitable for receiving the soiled bedding from cage bottoms 16a, and places cage bottoms 16a in an inverted fashion (open end facing down) on a tunnel washer conveyor 24 leading to a tunnel wash system 15, such as, for example, a continuous driven belt tunnel washer. Furthermore, soil side robot 11 also grasps, inverts, and places pallets 14a on tunnel washer conveyor 24 so they may be cleaned by tunnel wash system 15.

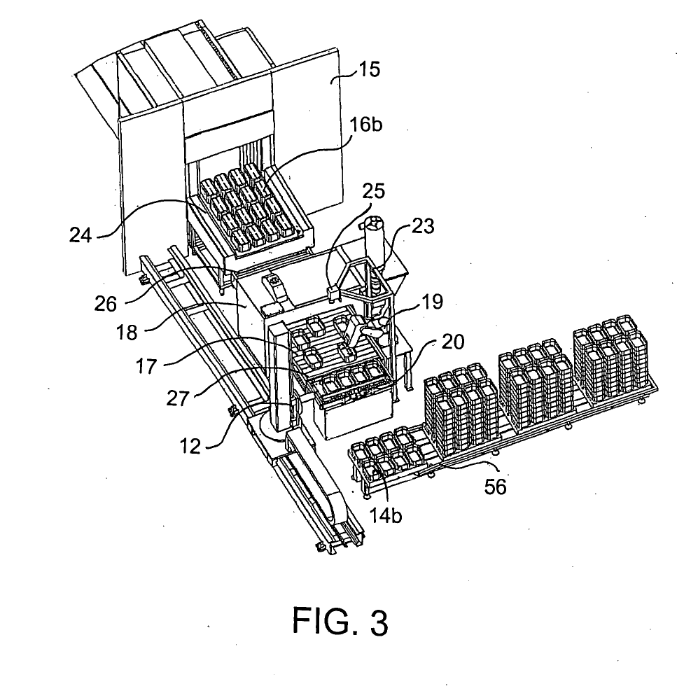

Once an appropriate number of soiled cage bottoms 16a and pallets 14a are received into tunnel washing system 15, cage bottoms 16a and pallets 14a are washed and dried by tunnel wash system 15. As best seen in FIGS. 1 and 3, upon completion of the wash/dry process in tunnel washing system 15, clean cage bottoms 16b and pallets 14b advance on tunnel washer conveyor 24, toward a rainfall type clean bedding dispenser 18. Prior to reaching rainfall type clean bedding dispenser 18, pallets 14b are removed from tunnel washer conveyor 24 by clean side robot 12 and placed either in a holding location or location that is suitable to receive clean cage bottoms 16b, such as an out-feed conveyor 56. Cleaned cage bottoms 16b drop from tunnel washer conveyor 24 to an inline conveyor 17. Inline conveyor 17 further comprises a receiving end 26 and a dispatch end 27. The drop from tunnel washer conveyor 24 to inline conveyor 17 causes clean cage bottoms 16b to invert (open end facing up) when clean cage bottoms 16b enter receiving end 26 of inline conveyor 17. The reorientation of clean cage bottoms 16b enables cage bottoms 16b to receive clean bedding from the rainfall type bedding dispenser 18.

The turbulent conditions of the tunnel washing process, as well as the reorientation of cage bottoms 16b onto inline conveyor 17, cause cage bottoms 16b to become skewed or disoriented. System 10 further comprises an optical arranger robot system for detecting skewed or disoriented cage bottoms 16b on inline conveyor 17, and placing cage bottoms 16b in an orderly arrangement upon a cage bottom re-grip station 20. Additionally, the optical arranger robot system can detect and reorient various cage bottoms, such as wire baskets used to transport water bottles, or serve to dispense bedding into cage bottoms.

In operation, as cage bottoms 16b with clean bedding progress toward dispatch end 27 of inline conveyor 17, they pass below an optical eye 25. Optical eye 25 is mounted on an elevated stationary structure 23 above inline conveyor 17. Optical eye 25 is aptly positioned to view a predetermined area of inline conveyor 17. While FIG. 3 shows optical eye 25 mounted on an elevated stationary structure 23, optical eye 25 may be mounted upon any suitable structure, such as, for example, optical arranger robot 19. Specifically, optical eye 25 transmits a video signal, presenting the position of the skewed cage bottoms to an encoding device (not shown). The encoding device serves to convert the video signals received from optical eye 25 into command signals suitable for guiding optical arranger robot 19.

Optical arranger robot 19 may be mounted adjacent to dispatch end 27 of inline conveyor 17 and cage bottom re-grip station 20 as illustrated in FIG. 3, or in any suitable position. As skewed cage bottoms progress toward optical arranger robot 19, optical arranger robot 19 receives a command signal from the encoding device (not shown), providing the position of the cage bottoms, and enabling the optical arranger robot 19 to grasp the cage bottoms and place them on cage bottom re-grip station 20. From cage bottom re-grip station 20, cage bottoms 16b are lifted by clean side robot 12, and stacked on clean pallet 14b so that cage bottoms 16b may be returned to service. Alternatively, clean side robot 12 may transfer cage bottoms 16b from re-grip station 20 directly to out-feed conveyor 56.

While the description set forth above describes the cleaning of cage bottoms 16b, the system 10 may be used for cleaning various other cage bottoms, such as grills for holding food and water and cage lids.

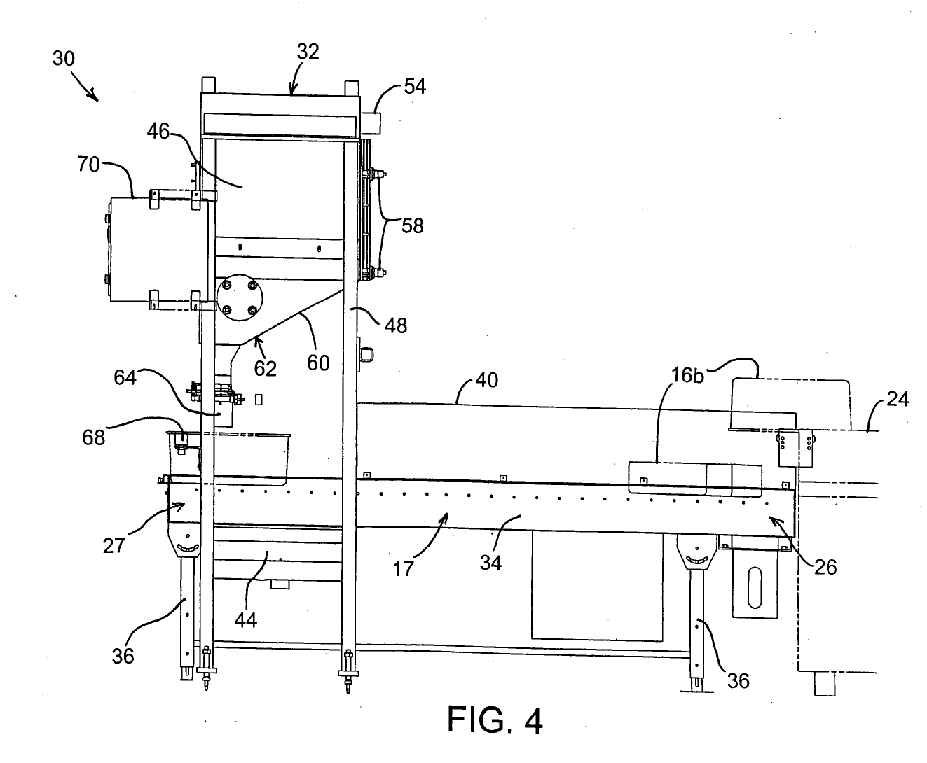

The present invention includes an improved bedding dispensing system 30 that may be used in place of the rainfall bedding dispenser 18 shown in FIG. 3. As best seen in FIGS. 4-6, bedding dispensing system 30 may include a main bedding dispensing unit 32 used in conjunction with inline conveyor 17.

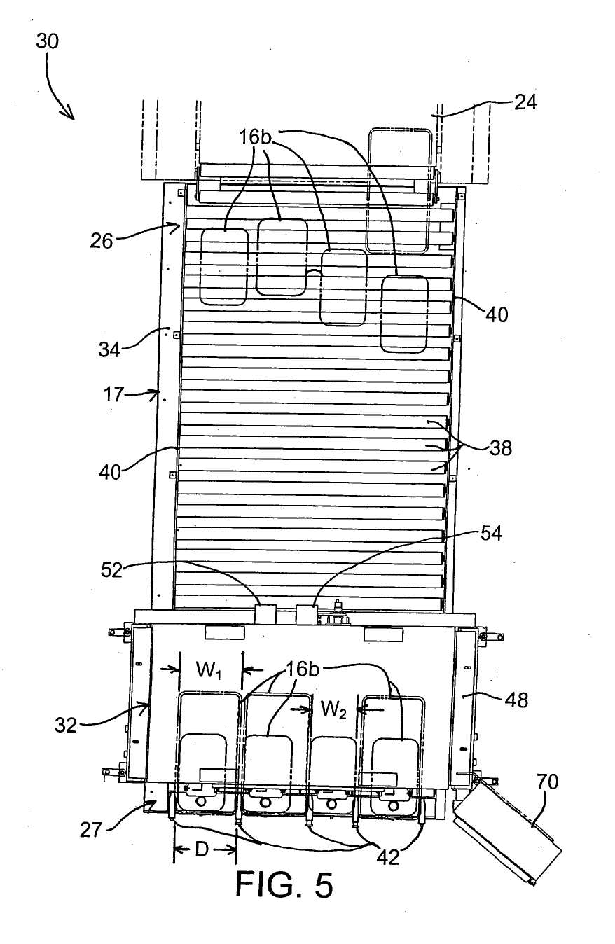

With particular reference to FIGS. 4 and 5, inline conveyor 17 is positioned downstream of tunnel conveyor washer 24 and includes receiving end 26 and dispatch end 27. As stated above, the drop from tunnel washer conveyor 24 to inline conveyor 17 causes clean cage bottoms 16b to invert (open end facing up) when clean cage bottoms 16b enter receiving end 26 of inline conveyor 17. Instead of being positioned in an intermediate location along inline conveyor 17 like rainfalls type dispenser 18, as shown in FIG. 3, main bedding dispensing unit 32 is positioned adjacent to dispatch end 27 of inline conveyor 17 and operates to accurately, efficiently and simultaneously dispense a metered amount of clean bedding into clean cage bottoms 16b.

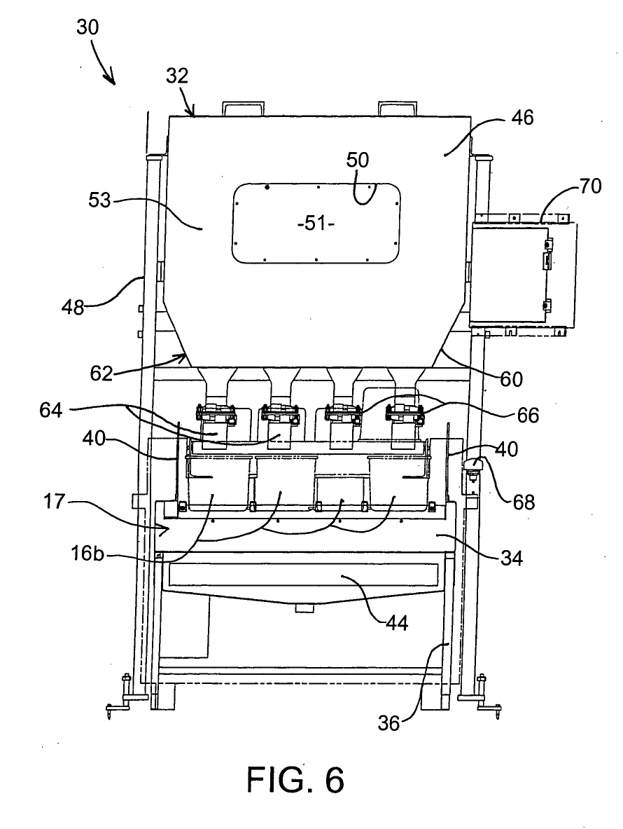

As best seen in FIGS. 4 and 5, inline conveyor 17 includes a frame 34 that is supported by a plurality of support members 36. A plurality of rollers 38 may be rotatably mounted to frame 34 and used to transport the clean cage bottoms 16b from receiving end 26 to dispatch end 27. Rollers 38 may be stainless steel and coated with a protective coating, such as Casta-lon soft protective coating, to help prevent cage bottoms 16b from chipping or cracking during operation. With additional reference to FIG. 6, inline conveyor 17 may include a pair of deflection shields 40 that extend upwardly from opposite sides of frame 34 that operate to retain cage bottoms 16b on inline conveyor 17.

As best seen in FIG. 5, one or more cage positioning guides 42 are mounted on dispatch end 27 of frame 34 and are arranged to position clean cage bottoms 16b in a filling position to receive clean bedding that is dispensed from main bedding dispensing unit 32. For example, each of cage positioning guides 40 may extend in a direction parallel with the longitudinal axis of inline conveyor 17 and spaced apart a distance (D) that is slightly larger than the width (W₁) of the cage bottoms 16b. It will be understood that cage position guides 40 may be adjustably mounted to a track or other mechanism that allows each of them to be repositioned to accommodate for cages having different widths (W₁, W₂).

One or more cage presence sensors may be used to determine the presence or absence of a cage bottom 16b in the filling position. For example, the cage presence sensors may be located underneath where a cage bottom would be located in the filling location to prevent the main bedding dispensing unit 32 from dispensing bedding in cage bottom 16b after bedding was already dispensed in that particular cage bottom. Cage presence sensors can also be used to prevent bedding from being dispensed by main bedding dispensing unit 32 when a cage bottom 16b is not located in the filling position.

As best seen in FIGS. 4 and 6, inline conveyor 17 may also include an overflow tray 44 that is slidably mounted to inline conveyor 17 and positioned underneath dispatch end 27 to catch any clean bedding that is not caught by cage bottoms 16b after being washed in tunnel washer conveyor 24. Overflow tray 44 may be slid out from underneath dispatch end 27 to empty any bedding material located therein. Inline conveyor 17 may also include a sloped water collection pan to accommodate and drain any excess water that drips off cage bottoms 16b. A drain connection and drain plug may be provided to assist in cleaning and draining of the excess water.

As best seen in FIGS. 4 and 6, main bedding dispensing unit 32 includes a bedding storage hopper 46 that is positioned above dispatch end 27 of inline conveyor 17. Bedding storage hopper 46 is supported by a hopper support frame 48 and is used as a storage compartment for clean bedding material. Specifically, clean bedding material may either be manually dumped into bedding storage hopper 46 through an access port 50 formed in a side wall 53 of bedding storage hopper 46, or automatically transported into the bedding storage hopper 46 using a pneumatic vacuum system. The access port 50 may be covered with a removable window 51 that prevents clean bedding material from spilling out of bedding storage hopper 46, and allows for visual verification of clean bedding levels within bedding storage hopper 46.

The vacuum system may include a vacuum that is connected to a vacuum port 52 that opens up into the internal chamber of bedding storage hopper 46. The vacuum system may also include a tube or other transportation means that is connected between a bedding supply source and a conveyance port 54 that also opens up into the internal chamber of bedding storage hopper 46. As the vacuum operates to draw air out of the internal chamber of bedding storage hopper 46, the clean bedding is drawn into the internal chamber of bedding storage hopper 46, thereby filling up bedding storage hopper 46. The level or amount of clean bedding material located in bedding storage hopper 46 may be determined using adjustable high/low capacitive sensors 58.

Bedding storage hopper 46 also may include a tapered section 60 at a bottom end 62 thereof that operates to funnel the clean bedding material to preferably three or four filling chutes 64. An agitator 65 may be located within bedding storage hopper 46 to agitate the clean bedding within bedding storage hopper 46 each time bedding is dispensed through filling chutes 64 and into a cage bottom. The agitation of the bedding material prevents the bedding material located in bedding storage hopper 46 from clumping and reduces bridging concerns associated with certain types of bedding materials.

As best seen in FIGS. 4 and 6, each of the filling chutes 64 may be positioned above the filling position where a respective cage bottom 16b may be aligned by cage positioning guides 42. Using separate filling chutes 64 for each cage bottom 16b increases the directional accuracy and concentration of bedding flow that is being dispensed, thereby reducing the amount of dust particulates that are suspended in the air during the filling of the cages. Since each of the filling chutes 64 are used to fill a single cage bottom, a substantial portion of the bedding that is dispensed through the filling chute 64 is captured by cage bottom, thereby reducing the amount of bedding that is wasted using the rainfall type bedding dispenser.

The amount of clean bedding material that is dispensed through each of the filling chutes 64 is controlled by one or more valves 66. Each of the valves 66 are coupled with a respective filling chute 64, wherein the valves 66 may be a pneumatic slide gate shutter valve or any other device that operates to meter the amount of clean bedding that flows through filling chutes 64 and into the cage bottoms 16b. Specifically, each of the valves 66 may be opened and then closed to dispense a specific amount of bedding material into a cage bottom 16b by touching a control button 68, which is in turn connected to an operator control interface 70.

Operator control interface 70 may operate to display the status of system 30, allow the operator to control the type of cage to be filled, allow the dispensing volumes to be adjusted by controlling the amount of time that valves 66 are in an open position, control the operation of agitator 65, and provide a start and stop time for each filling cycle. Operator control interface 70 may also be configured to communicate with a main control center or server through a network to accept communications from an external source, communicate with other bedding dispensing systems, and allow for software control, upgrades, maintenance, and fault isolation. In addition to allowing an operator to visually determine the amount of bedding material located within bedding storage hopper 46 through window 51, control interface 70 may be connected to capacitive sensors 58 to allow the operator to monitor the level of bedding material located within the bedding storage hopper 46.

In operation, clean bedding materials may be placed into bedding storage hopper 46 either manually or automatically. If the bedding is placed in the bedding storage hopper 46 manually, the window 51 that covers access port 50 may be removed so that the bedding may be inserted into the internal chamber through access port 50. If the bedding is placed in the bedding storage hopper 46 automatically using the vacuum system, a vacuum is turned on, thereby drawing air out of the internal chamber of bedding storage hopper 46 through vacuum port 52. The vacuum pressure in turn draws clean bedding from the bedding supply source into the internal chamber of bedding storage hopper 46 through conveyance port 54. The automatic bedding filling can be controlled by control interface 70, which may be used to selectively turn the vacuum on and off. It will be understood that bedding storage hopper 46 may be filled before, during or after the cage bottoms 16b are filled with clean bedding to provide for an efficient cage washing and filling system.

The cage positioning guides 42 may be manually adjusted, or automatically adjusted by operator interface 70, to the distance (D) that is slightly greater than the width (W₁, W₂) of the cage bottom that will be filled to properly align each of the cage bottoms beneath a respective filling chute 64.

Upon completion of the wash/dry process in tunnel washing system 15, clean cage bottoms 16b may advance on tunnel washer conveyor 24, toward bedding dispensing system 30. As best seen in FIG. 4, cleaned cage bottoms 16b drop from tunnel washer conveyor 24 to inline conveyor 17. The drop from tunnel washer conveyor 24 to inline conveyor 17 causes clean cage bottoms 16b to invert (open end facing up) when clean cage bottoms 16b enter receiving end 26 of inline conveyor 17.

The turbulent conditions of the tunnel washing process, as well as the reorientation of cage bottoms 16b onto inline conveyor 17, cause cage bottoms 16b to become skewed or disoriented. Cage bottoms 16b are prevented from falling off of inline conveyor 17 by deflection shields 40 positioned on opposite sides of inline conveyor 17. As cage bottoms 16b approach dispatch end 27 of inline conveyor 17, cage bottoms 16b are placed in the filling position between a pair of cage positioning guides 42 to properly position cage bottoms underneath a respective filling chute 64. It will be understood that cage bottoms 16b may be manually placed between cage positioning guides 42 by an operator, or automatically placed using optical arranger robot 19 (FIG. 3). The cage presence sensors then operate to sense the presence of a cage bottom 16b in the filling position.

The operator interface 70 is then instructed to simultaneously dispense a metered amount of clean bedding material into cage bottoms 16b using control button 68. After control button 68 is activated, a signal is sent to operator interface 70 indicating that the valves 66 should be opened to simultaneously dispense clean bedding material into cage bottoms 16b. It will be understood that operator interface 70 will only instruct clean bedding to be dispensed through those valves 66 and associated filling chutes 64 that have a cage bottom 16b located in a respective filling position, which is determined by the cage presence sensors. The amount of time that each valve is in the open position to dispense bedding at least in part depends on the amount of bedding that is to be dispensed into each cage bottom and the flow rate of the bedding that is dispensed from filling chute 64. It will be understood that each of the valves 66 and associated filling chutes 64 can operate to dispense the same amount or different amounts of bedding material relative to one another. Therefore, various sizes and types of cage bottoms are simultaneously filled using bedding dispensing system 30, even if they need to be filled with different amounts of clean bedding. As clean bedding is being dispensed into one or more cage bottoms 16b from bedding storage hopper 46, agitator 65 may be turned on by operator interface 70 to reduce the chance that the clean bedding will clump in the tapered portion 60 of bedding storage hopper 46.

After valves 66 have closed and clean bedding is no longer being dispensed into cage bottoms 16b, the cage presence sensors continue to sense that the same cage bottom 16b is located in the fill position and prevents the main bedding from dispensing bedding for a second time in the same cage bottom. Cage bottoms 16b may then be manually lifted, or automatically lifted by clean side robot 12, and stacked on clean pallet 14b so that cage bottoms 16b may be returned to service. Alternatively, clean side robot 12 may transfer cage bottoms 16b from dispatch end 27 directly to out-feed conveyor 56 as seen in FIG. 3. Once the cage bottoms are removed from dispatch end 27 of inline conveyor 17, cage presence sensors are used to prevent bedding from being dispensed by main bedding dispensing unit 32 until another cage bottom is placed in the filling position.

The bedding dispensing system described above provides a number of advantages over existing rainfall type bedding dispensers. For example, the present invention includes a main bedding dispensing unit positioned at a dispatch end of the inline conveyor having separate filling chutes for each cage bottom. The use of three or four separate filling chutes allows multiple cage bottoms to be simultaneously filled with a specific amount of clean bedding material to efficiently fill the cage bottoms and reduce the amount of clean bedding that is wasted. Thus, different types and sizes of cage bottoms can be filled using the bedding dispensing system. Further, the use of separate filling chutes allows the clean bedding material to be directly dispensed into the cage bottom, thereby reducing the amount of bedding particulates that are suspended in the air during the dispensing process. Moreover, the main bedding dispensing unit includes a window covering an access port on the side of the bedding storage hopper for identifying how much clean bedding is located within the bedding storage hopper.

Although the present invention has been described in considerable detail with reference to certain preferred versions thereof, other versions are possible. Therefore, the spirit and scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A system for dispensing clean bedding material in a plurality of cage components, the system comprising:
an inline conveyor having a receiving end and a dispatch end, wherein the inline conveyor transports the plurality of cage components from the receiving end to a filling position located at the dispatch end; and
a bedding dispensing unit positioned over the dispatch end of the inline conveyor, wherein the bedding dispensing unit operates to simultaneously dispense clean bedding into the plurality of cage components.

2. A system as described in claim 1, wherein the inline conveyor includes at least one cage positioning guide that positions the plurality of cage components underneath the bedding dispensing unit in the filling position.

3. A system as described in claim 2, further comprising at least one cage presence sensor that is used to determine when the plurality of cage components are located in the filling position.

4. A system as described in claim 1, wherein the bedding dispensing unit includes a bedding storage hopper having an internal chamber for storing the bedding material.

5. A system as described in claim 4, wherein the bedding storage hopper includes a plurality of filling chutes positioned over each of the filling positions to simultaneously dispense the bedding material from the internal chamber into the plurality of cage components.

6. A system as described in claim 5, wherein the bedding storage hopper includes bottom end having a tapered portion that funnels toward the plurality of filling chutes.

7. A system as described in claim 6, wherein a valve is coupled with at least one of the plurality of filling chutes to control the amount of bedding dispensed by the filling chutes.

8. A system as described in claim 7, wherein the valve is a pneumatic shutter valve.

9. A system as described in claim 7, further comprising an operator interface for selectively opening and closing the valve to control amount of bedding dispensed by the filling chutes.

10. A system as described in claim 4, wherein the bedding storage hopper includes a window.

11. A system as described in claim 4, wherein the bedding storage hopper includes four filling chutes.

12. A system as described in claim 4, further comprising an agitator positioned within the internal chamber of the bedding storage hopper.

13. A bedding dispensing unit for dispensing bedding material into a plurality of cage components positioned on an inline conveyor in a filling position, the dispensing unit comprising:
a bedding storage hopper having an internal chamber for storing the bedding material and a window for viewing the amount of bedding contained within the internal chamber; and
a plurality of filling chutes positioned over the filling position to simultaneously dispense the bedding material from the internal chamber into the plurality of cage components.

14. A dispensing unit as described in claim 13, wherein the bedding storage hopper includes bottom end having a tapered portion that funnels toward the plurality of filling chutes.

15. A dispensing unit as described in claim 14, wherein a valve is coupled with the plurality of filling chutes to control the amount of bedding dispensed by the filling chutes.

16. A dispensing unit as described in claim 15, wherein the valve is a pneumatic shutter valve.

17. A dispensing unit as described in claim 15, further comprising an operator interface for selectively opening and closing the valve to control amount of bedding dispensed by the filling chutes.

18. A dispensing unit as described in claim 13, wherein the bedding storage hopper includes four filling chutes.

19. A dispensing unit as described in claim 13, further comprising an agitator positioned within the internal chamber of the bedding storage hopper.

20. A method for filling a plurality of cage components with bedding material, the method comprising:
providing an inline conveyor having a receiving end and a dispatch end;
positioning a bedding dispensing unit over the dispatch end of the inline conveyor;
transporting each of a plurality of cage components from the receiving end to a respective filling position located at the dispatch end; and
simultaneously dispensing clean bedding from the internal chamber of the bedding dispensing unit into the plurality of cage components.

21. A method as described in claim 20, further comprising:
providing at least one cage positioning guide on the inline conveyor; and
using the at least one cage positioning guide to position the plurality of cage components underneath the bedding dispensing unit in the respective filling positions.

22. A method as described in claim 20, further comprising sensing when the plurality of cage components are located in the respective filling positions.

23. A method as described in claim 20, wherein the amount of bedding material in the bedding dispensing unit can be seen through a window in the bedding dispensing unit.

24. A method as described in claim 20, further comprising agitating the bedding material when the bedding material is dispensed into the plurality of cage components.

25. A method as described in claim 20, wherein the bedding dispensing unit includes four filling chutes.
